(19) United States
(12) Patent Application Publication
(10) Pub. No.: US 2010/0185994 A1
(43) Pub. Date: Jul. 22, 2010

(54) Topological Pattern Matching

(76) Inventors: Fedor G. Pikus, Beaverton, OR (US); Truman W. Collins, JR., Lake Oswego, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/541,905

(22) Filed: Aug. 14, 2009

Related U.S. Application Data
(60) Provisional application No. 61/089,023, filed on Aug. 14, 2008.

(51) Int. Cl. G06F 17/50

(52) U.S. Cl. 716/5

(57) ABSTRACT

Techniques for more efficiently identifying specific topological patterns in microdevice design data, such as layout design data. A user provides a topological pattern matching tool with a pattern template. In response, the topological pattern matching tool will analyze the pattern template to create a set of “design rule check” operations that can be performed to identify topological features of the layout design that will include the set of topological features specified for the template. The topological pattern matching tool also specifies properties that should be determined for each set of topological features identified by a design rule check operation. Once the design rule check operations have been created, the tool applies them to the layout design data being analyzed. The results produced by the design rule check operations will be a group of topological features in the layout design that encompass the topological features specified for the template. The results also will include a set of properties for each of the identified topological features. Next, the pattern matching tool creates a search graph based upon the results of the design rule check operations. Once the search graph is constructed, the pattern matching tool traverses the search graph to identify combinations of nodes connected by graph edges representing feature characteristics that match the constraints specified for the pattern template. For each such identified combination of nodes, the tool will output the arrangement of geometric elements corresponding to the nodes as a topological match to the original template.

### RELATED APPLICATIONS

This application claims priority under 35 U.S.C. §119 to U.S. Provisional Patent Application No. 61/089,023, filed Aug. 14, 2009, entitled “Topological Pattern Matching,” and naming Truman W. Collins et al., which application is incorporated entirely herein by reference.

### FIELD OF THE INVENTION

The present invention is directed to the matching of topological patterns. Various implementations of the invention may be useful for identifying occurrences of a topological pattern in microdevice design data, such as layout design data.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit being designed, its complexity, the design team, and the microcircuit fabricator or foundry that will manufacture the microcircuit. Typically, software and hardware “tools” will verify a design at various stages of the design flow by running software simulators and/or hardware emulators, and errors in the design are corrected.

Several steps are common to most design flows. Initially, the specification for the new microcircuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logical of the circuit is then analyzed, to confirm that the logic incorporated into the design will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This logical generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the functions desired for the circuit. This analysis is sometimes referred to as “formal verification.”

Once the relationships between circuit devices have been established, the design is again transformed, this time into a physical design that describes specific geometric elements. This type of design often is referred to as a “layout” design. The geometric elements define the shapes that will be created in various materials to actually manufacture the circuit device components (e.g., contacts, gates, etc.) making up the circuit. While the geometric elements are typically polygons, other shapes, such as circular and elliptical shapes, also may be employed. These geometric elements may be custom designed, selected from a library of previously-created designs, or some combination of both. Geometric elements also are added to form the connection lines that will interconnect these circuit devices. Layout tools (often referred to as “place and route” tools), such as Mentor Graphics' IC Station or Cadence's Virtuoso, are commonly used for both of these tasks.

With a layout design, each physical layer of the microcircuit will have a corresponding layer representation, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires used will be formed to connect the circuit devices. Typically, a designer will perform a number of analyses on the layout design. For example, the layout design may be analyzed to confirm that it accurately represents the circuit devices and their relationships described in the device design. The layout design also may be analyzed to confirm that it complies with various design requirements, such as minimum spacings between geometric elements. Still further, it may be modified to include the use of redundant or other compensatory geometric elements intended to counteract limitations in the manufacturing process, etc.

After the layout design has been finalized, then it is converted into a format that can be employed by a mask or reticle writing tool to create a mask or reticle for use in a photolithographic manufacturing process. Masks and reticles are typically made using tools that expose a blank reticle to an electron or laser beam. Most mask writing tools are able to only “write” certain kinds of polygons, however, such as right triangles, rectangles or other trapezoids. Moreover, the sizes of the polygons are limited physically by the maximum beam aperture size available to the tool. Accordingly, larger geometric elements in the layout design, or geometric elements that are not basic right triangles, rectangles or trapezoids (which typically is a majority of the geometric elements in a layout design) must be “fractured” into the smaller, more basic polygons that can be written by the mask or reticle writing tool, and then converted to a format compatible with the mask or reticle writing tool.

As previously noted, a designer will perform a number of analyses on the layout design before the design is finalized used to create photolithographic masks. With a variety of these analyses, it is sometimes useful for a designer to identify specific structural relationships described in the layout design. For example, a designer may determine that an arrangement of geometric elements in the design can be modified to improve its manufacturability. The designer would then seek to identify other occurrences of that arrangement in the layout design, so that those occurrences can be modified as well. Because of the size and complexity of modern circuit designs, however, it may be computationally difficult and time consuming to identify other occurrences of that arrangement that match the alignment of the original template arrangement. It may be even more difficult to identify occurrences of that arrangement that are rotated, inverted, or both with respect to the original template arrangement.

### BRIEF SUMMARY OF THE INVENTION

Aspects of the invention relate to techniques of more efficiently identifying specific topological patterns in microdevice design data, such as layout design data. By efficiently searching for topological patterns in a layout design that match a template pattern, a designer can, for example, locate desired occurrences of geometric element arrangements in the design.

According to various implementations of the invention, a user provides a topological pattern matching tool with a pattern template. This pattern template will specify a set of topological features, and may include a set of constraints that determine how similar another topology must be to the template topology in order to be considered a match. A typical topological feature may be, e.g., a pair of edges and a relationship between those edges (e.g., distance between the edges, projection length of one edge onto another, angle between abutting edges, etc.) In response, the topological pattern matching tool will analyze the pattern template to create a set of “design rule check” operations that can be performed to identify topological features of the layout design that will include the set of topological features specified for the template. The topological pattern matching tool also specifies properties that should be determined for each set of topological features identified by a design rule check operation.

Once the design rule check operations have been created, the tool applies them to the layout design data being analyzed. The results produced by the design rule check operations will be a group of topological features in the layout design that encompass the topological features specified for the template. The results also will include a set of properties for each of the identified topological features. Typically, the properties will include a unique identifier for the topological feature and one or more characteristics of the topological feature.

Next, the pattern matching tool creates a search graph based upon the results of the design rule check operations. More particularly, the pattern matching tool will create a set of nodes corresponding to each topological feature identified by the design rule check operations, with the graph edges between the nodes representing the characteristics of that topological feature. For example, if a topological feature is comprised of two geometric edges in a layout design, each geometric edge will be represented by a node in the search graph, with a graph edge linking the associated nodes. Moreover, the graph edge will represent one or more characteristics of the geometric feature, such as the distance between the geometric edges. Once the search graph is constructed, the pattern matching tool traverses the search graph to identify combinations of nodes connected by graph edges representing feature characteristics that match the constraints specified for the pattern template. For each such identified combination of nodes, the tool will output the arrangement of geometric elements corresponding to the nodes as a topological match to the original template.

These and other features and aspects of the invention will be apparent upon consideration of the following detailed description.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 illustrates an example of a topological pattern matching tool that may be implemented according to various embodiments of the invention.

FIG. 4 shows a graphical example of a pattern template that may be provided to a topological pattern matching tool according to various embodiments of the invention.

FIG. 5 illustrates a portion of a layout design

### DETAILED DESCRIPTION OF THE INVENTION

### Exemplary Operating Environment

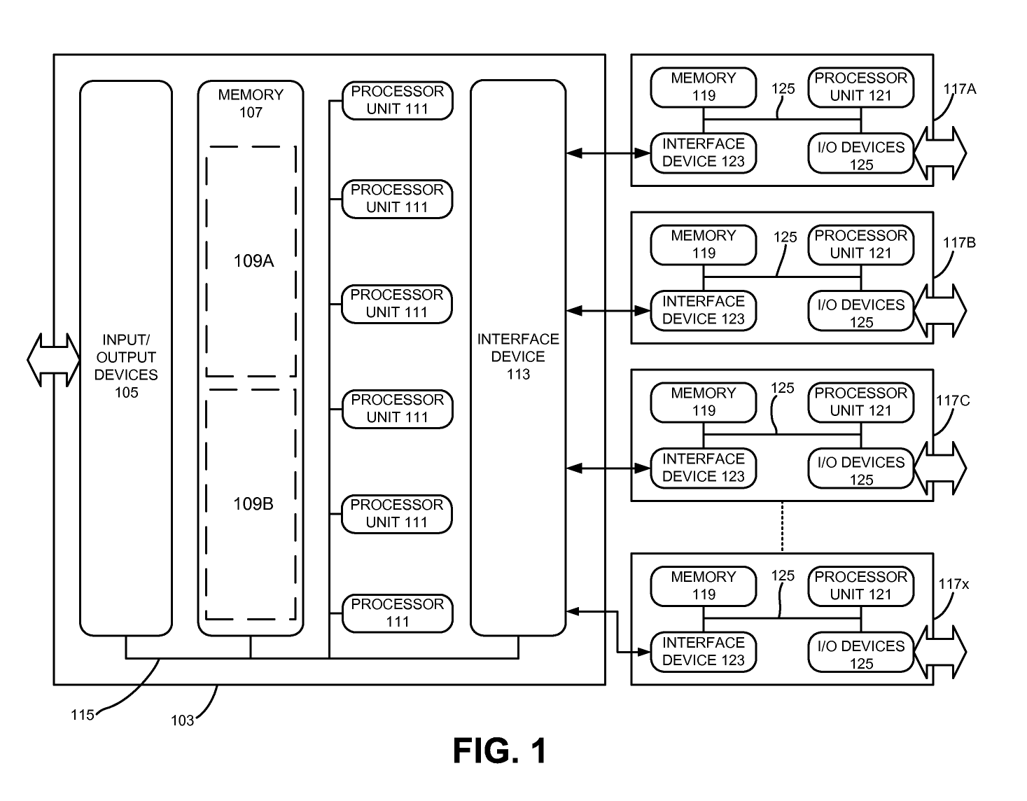

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

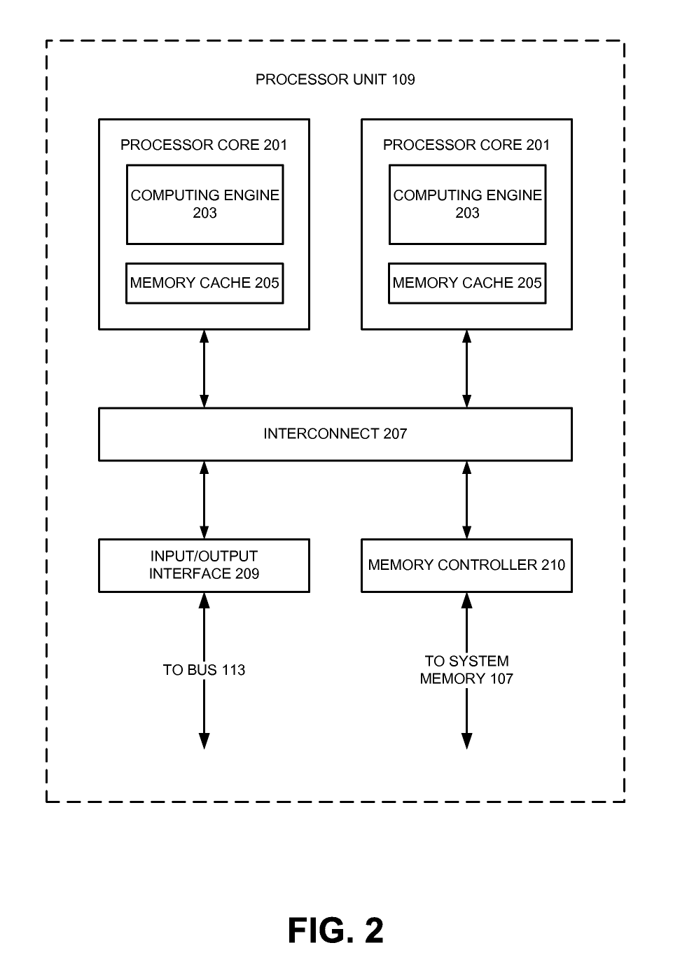

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Analysis Of Layout Design Data

As previously noted, various embodiments of the invention are related to electronic design automation. In particular, various implementations of the invention may be used to improve the operation of electronic design automation software tools that identify, verify and/or modify layout design data for manufacturing a microdevice, such as a microcircuit. As used herein, the terms “design” and “design data” are intended to encompass data describing an entire microdevice, such as an integrated circuit device or micro-electromechanical system (MEMS) device. This term also is intended to encompass a smaller set of data describing one or more components of an entire microdevice, however, such as a layer of an integrated circuit device, or even a portion of a layer of an integrated circuit device. Still further, the terms “design” and “design data” also are intended to encompass data describing more than one microdevice, such as data to be used to create a mask or reticle for simultaneously forming multiple microdevices on a single wafer.

Designing and fabricating microcircuit devices involve many steps during a ‘design flow’ process. These steps are highly dependent on the type of microcircuit, its complexity, the design team, and the fabricator or foundry that will manufacture the microcircuit from the design. Several steps are common to most design flows, however. First, a design specification is modeled logically, typically in a hardware design language (HDL). Once a logical design has been created, various logical analysis processes are performed on the design to verify its correctness. More particularly, software and hardware “tools” verify that the logical design will provide the desired functionality at various stages of the design flow by running software simulators and/or hardware emulators, and errors are corrected. For example, a designer may employ one or more functional logic verification processes to verify that, given a specified input, the devices in a logical design will perform in the desired manner and provide the appropriate output.

After the logical design is deemed satisfactory, it is converted into physical design data by synthesis software. This physical design data or “layout” design data may represent, for example, the geometric elements that will be written onto a mask used to fabricate the desired microcircuit device in a photolithographic process at a foundry. For conventional mask or reticle writing tools, the geometric elements typically will be polygons of various shapes. Thus, the layout design data usually includes polygon data describing the features of polygons in the design. It is very important that the physical design information accurately embody the design specification and logical design for proper operation of the device. Accordingly, after it has been created during a synthesis process, the physical design data is compared with the original logical design schematic in a process sometimes referred to as a “layout-versus-schematic” (LVS) process.

Once the correctness of the logical design has been verified, and geometric data corresponding to the logical design has been created in a layout design, the geometric data then may be analyzed. For example, because the physical design data is employed to create masks used at a foundry, the data must conform to the foundry's requirements. Each foundry specifies its own physical design parameters for compliance with their processes, equipment, and techniques. Accordingly, the design flow may include a process to confirm that the design data complies with the specified parameters. During this process, the physical layout of the circuit design is compared with design rules in a process commonly referred to as a “design rule check” (DRC) process. In addition to rules specified by the foundry, the design rule check process may also check the physical layout of the circuit design against other design rules, such as those obtained from test chips, general knowledge in the industry, previous manufacturing experience, etc.

With modern electronic design automation design flows, a designer may additionally employ one or more “design-for-manufacture” (DFM) software tools. As previously noted, design rule check processes attempt to identify, e.g., elements representing structures that will almost certainly be improperly formed during a manufacturing process. “Design-For-Manufacture” tools, however, provide processes that attempt to identify elements in a design representing structures with a significant likelihood of being improperly formed during the manufacturing process. A “design-for-manufacture” process may additionally determine what impact the improper formation of the identified elements will have on the yield of devices manufactured from the circuit design, and/or modifications that will reduce the likelihood that the identified elements will be improperly formed during the manufacturing process. For example, a “design-for-manufacture” (DFM) software tool may identify wires that are connected by only a single via, determine the yield impact for manufacturing a circuit from the design based upon the probability that each individual single via will be improperly formed during the manufacturing process, and then identify areas where redundant vias can be formed to supplement the single vias.

It should be noted that, in addition to “design-for-manufacture,” various alternate terms are used in the electronic design automation industry. Accordingly, as used herein, the term “design-for-manufacture” or “design-for-manufacturing” is intended to encompass any electronic design automation process that identifies elements in a design representing structures that may be improperly formed during the manufacturing process. Thus, “design-for-manufacture” (DFM) software tools will include, for example, “lithographic friendly design” (LFD) tools that assist designers to make trade-off decisions on how to create a circuit design that is more robust and less sensitive to lithographic process windows. They will also include “design-for-yield” (DFY) electronic design automation tools, “yield assistance” electronic design automation tools, and “chip cleaning” and “design cleaning” electronic design automation tools.

After a designer has used one or more geometry analysis processes to verify that the physical layout of the circuit design is satisfactory, the designer may then perform one or more simulation processes to simulate the operation of a manufacturing process, in order to determine how the design will actually be realized by that particular manufacturing process. A simulation analysis process may additionally modify the design to address any problems identified by the simulation. For example, some design flows may employ one or more processes to simulate the image formed by the physical layout of the circuit design during a photolithographic process, and then modify the layout design to improve the resolution of the image that it will produce during a photolithography process.

These resolution enhancement techniques (RET) may include, for example, modifying the physical layout using optical proximity correction (OPC) or by the addition of sub-resolution assist features (SRAF). Other simulation analysis processes may include, for example, phase shift mask (PSM) simulation analysis processes, etch simulation analysis processes and planarization simulation analysis processes. Etch simulation analysis processes simulate the removal of materials during a chemical etching process, while planarization simulation processes simulate the polishing of the circuit's surface during a chemical-mechanical etching process. These simulation analysis processes may identify, for example, regions where an etch or polishing process will not leave a sufficiently planar surface. These simulation analysis processes may then modify the physical layout design to, e.g., include more geometric elements in those regions to increase their density.

It should be appreciated that various design flows may repeat one or more processes in any desired order. Thus, with some design flows, geometric analysis processes can be interleaved with simulation analysis processes and/or logical analysis processes. For example, once the physical layout of the circuit design has been modified using resolution enhancement techniques, then a design rule check process or design-for-manufacturing process may be performed on the modified layout, Further, these processes may be alternately repeated until a desired degree of resolution for the design is obtained. Similarly, a design rule check process and/or a design-for-manufacturing process may be employed after an optical proximity correction process, a phase shift mask simulation analysis process, an etch simulation analysis process or a planarization simulation analysis process. Examples of electronic design tools that employ one or more of the logical analysis processes, geometry analysis processes or simulation analysis processes discussed above are described in U.S. Pat. No. 6,230,299 to McSherry et al., issued May 8, 2001, U.S. Pat. No. 6,249,903 to McSherry et al., issued Jun. 19, 2001, U.S. Pat. No. 6,339,836 to Eisenhofer et al., issued Jan. 15, 2002, U.S. Pat. No. 6,397,372 to Bozkus et al., issued May 28, 2002, U.S. Pat. No. 6,415,421 to Anderson et al., issued Jul. 2, 2002, and U.S. Pat. No. 6,425,113 to Anderson et al., issued Jul. 23, 2002, each of which are incorporated entirely herein by reference.

### Data Organization

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells.

By categorizing microcircuit design data into hierarchical cells, large data structures can be processed more quickly and efficiently. For example, a circuit designer typically will analyze a design to ensure that each circuit feature described in the design complies with specified design rules. With the above example, instead of having to analyze each feature in the entire 128 kB memory array, a design rule check process can analyze the features in a single bit cell. If the cells are identical, then the results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

With various examples of the invention, layout design data may include two different types of data: “drawn layer” design data and “derived layer” design data. The drawn layer data describes geometric elements that will be used to form structures in layers of material to produce the integrated circuit. The drawn layer data will usually include polygons that will be used to form structures in metal layers, diffusion layers, and polysilicon layers. The derived layers will then include features made up of combinations of drawn layer data and other derived layer data. Thus, with a transistor gate, derived layer design data describing the gate may be derived from the intersection of a polygon in the polysilicon material layer and a polygon in the diffusion material layer.

For example, a design rule check process performed by the design rule check module 309 typically will perform two types of operations: “check” operations that confirm whether design data values comply with specified parameters, and “derivation” operations that create derived layer data. A transistor gate design data thus may be created by the following derivation operation:

gate=diff AND poly

The results of this operation will be a “layer” of data identifying all intersections of diffusion layer polygons with polysilicon layer polygons. Likewise, a p-type transistor gate, formed by doping the diffusion layer with n-type material, is identified by the following derivation operation:

pgate=nwell AND gate

The results of this operation then will be another “layer” of data identifying all transistor gates (i.e., intersections of diffusion layer polygons with polysilicon layer polygons) where the polygons in the diffusion layer have been doped with n-type material.

A check operation performed by the design rule check module 309 will then define a parameter or a parameter range for a data design value. For example, a user may want to ensure that no metal wiring line is within a micron of another wiring line. This type of analysis may be performed by the following check operation:

external metal<1

The results of this operation will identify each polygon in the metal layer design data that are closer than one micron to another polygon in the metal layer design data.

Also, while the above operation employs drawn layer data, check operations may be performed on derived layer data as well. For example, if a user wanted to confirm that no transistor gate is located within one micron of another gate, the design rule check process might include the following check operation:

external gate<1

The results of this operation will identify all gate design data representing gates that are positioned less than one micron from another gate. It should be appreciated, however, that this check operation cannot be performed until a derivation operation identifying the gates from the drawn layer design data has been performed.

### Topological Pattern Matching Tool

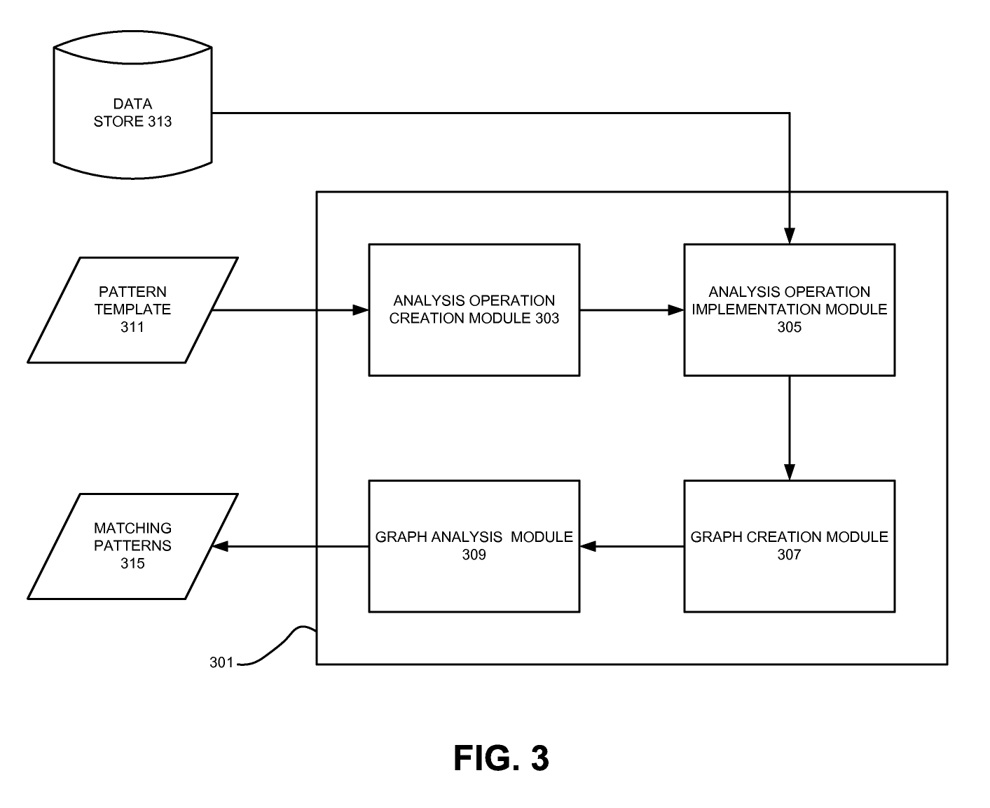

FIG. 3 illustrates a topological pattern matching tool 301 that may be implemented according to various examples of the invention. As seen in this figure, the topological pattern matching tool 301 includes an analysis operation creation module 303, an analysis operation implementation module 305, a graph creation module 307, and a graph analysis module 309. Each of these modules may be embodiment by the implementation of software instruction on a computing system, such as a computing system of the type described with regard to FIGS. 1 and 2, or by the operation of such a computing system itself.

Initially, a user will provides the analysis operation creation module 303 with a pattern template 311. As will be discussed in more detail below, this pattern template will specify a set of topological features, and may include a set of constraints that determine how similar another topology must be to the template topology in order to be considered a match. A typical topological feature may be, e.g., a pair of edges and a relationship between those edges (e.g., distance between the edges, projection length of one edge onto another, angle between abutting edges, etc.)

In response, the analysis operation creation module 303 will analyze the pattern template to create a set of “design rule check” operations that can be performed to identify topological features of the layout design that will include the set of topological features specified for the template. The analysis operation creation module 303 also specifies properties that should be determined for each set of topological features identified by a design rule check operation. As will be discussed in more detail below, the properties identified during the design rule check operation may be values associated with or determined by the topology described by the layout design data.

Once the analysis operation creation module 303 has created the desired design rule check operations, the analysis operation implementation module 305 applies these design rule check operations to the layout design data being analyzed. With various examples of the invention, the layout design data may be retrieved from a separate data store 313. The results produced by the design rule check operations will be a group of topological features in the layout design that encompass the topological features specified for the template. The results also will include a set of properties for each of the identified topological features. Typically, the properties will include a unique identifier for the topological feature and one or more characteristics of the topological feature.

Next, the graph creation module 307 creates a search graph based upon the results of the design rule check operations. More particularly, the graph creation module 307 will create a set of nodes corresponding to each topological feature identified by the design rule check operations, with the graph edges between the nodes representing the characteristics of that topological feature. For example, if a topological feature is comprised of two geometric edges in a layout design, each geometric edge will be represented by a node in the search graph, with a graph edge linking the associated nodes. Moreover, the graph edge will represent one or more characteristics of the geometric feature, such as the distance between the geometric edges. Once the search graph is constructed, the graph analysis module 309 traverses the search graph to identify combinations of nodes connected by graph edges representing feature characteristics that match the constraints specified for the pattern template. For each such identified combination of nodes, the graph analysis module 309 will output the arrangement of geometric elements corresponding to the nodes as a topological match to the original template.

### Pattern Template

The input to the topological pattern matching tool 301 may be a graph represented textually. Some implementations of the invention may alternately or additionally allow a user to graphically generate a pattern template specification. The pattern is defined by vertices and points with coordinate values, and edges connecting them. Constraints may be given, allowing for variations from this basic pattern as far as edge length, distance between edges, and distance between vertices. The pattern may also have endpoints, referred to herein as “points,” that may not correspond to vertexes in matching input geometry. Multiple polygons may be represented in the pattern and may slide around relative to each other to a certain extent, but they may not rotate relative to one another.

If the topological pattern matching tool 301 is implemented within the Calibre® family of software tools available from Mentor Graphics Corporation of Wilsonville, Oreg., then the operation of the topological pattern matching tool 301 may be initiated using the following SVRF command:

output layer=DFM PATTERN MATCH input layer pattern spec file

The input layer must be a merged layer. The pattern specification file is a pathname to the file describing the pattern to search for. The format, content, and meaning of this file are described in the sections below. The output of this command will be a derived layer of layout data comprising the geometry matching this or any one of the seven flipped and/or rotated related patterns. If the pattern contains partial polygons, the output will be clipped at these boundaries.

A variety of terms will be used with regard to an explanation of an input template pattern that may be used according to various embodiments of the invention. These terms are defined as follows:
Basic layout: The sample pattern defines the basic layout of the polygons in the pattern. Range constraints may be defined between polygons such that geometry matching the pattern may have polygons in somewhat different places from the sample pattern. The basic layout defines the general locations that polygons can be in relative to one another. Two edges that directly face each other in the sample pattern must face each other in geometry found to match the pattern.
Constraint: The defined distance between a pair of vertices, points, and/or edges which is either a specific amount or a range.
Explicit constraint: An explicitly defined distance constraint between a pair of vertices, points, and/or edges in the pattern. It may be a single value, a range, a constraint that two distances must have the same value, or it may enable a previously disabled implicit constraint.
Implicit constraint: A constraint between two fixed vertices or two fixed facing edges in the pattern that is implicitly defined. In a pattern with no explicit constraints, there is no flexibility to the pattern, and the distance between all pairs of vertices and all pairs of facing edges are implicitly constrained to be the distance in the sample pattern. Implicit constraints are disabled between all vertex pairs in two different polygons if an explicit constraint is defined between any vertex pairs in the two polygons.
Point: A location in the pattern that may either fall on an edge or vertex of a matching piece of geometry. It is used to indicate the extent of the match of a partial polygon.
Sample pattern: This is the pattern as described in the input file without taking into account any potential range constraints.
Window of interest: Conceptually, this is the part of the sample pattern that is of interest and will be copied into the output. The sample pattern is the entire window of interest. Since the pattern may contain points, this concept is useful because the pattern may cover only part of a polygon that is matched.
Vertex: A vertex in the pattern corresponds to an actual vertex in a matching piece of geometry. It may be fixed with respect to the other fixed vertices in the pattern or it may be floating if its exact location is unknown due to a range constraint.

With various examples of the invention, the pattern template may be input textually in three sections. The first two sections describe a sample pattern using vertices, points, and edges, which describe one or more polygons. The third section is a description of constraints among vertices, points, and edges that allow flexibility beyond the sample pattern.

In the first section, vertices and points are listed, each with a label and coordinates in the sample pattern. Vertices in the pattern correspond to vertices in a match found in the input. Points are used to indicate the minimum required extent of an edge and indicate where a found instance of the pattern is clipped. The second section lists labeled edges, each between two named vertices and/or points. Each vertex and each point is the endpoint of two or more edges. Edges are defined between points where matching geometry will be clipped.

The third section lists named constraints. Typically, these will be distances or distance ranges between a pair of vertices, points, and/or edges. An empty constraint may also be given, which means that the distance in the sample pattern is the exact distance that will constitute a match. These are only necessary to re-instantiate implicit constraints that have become disabled. A constraint may be declared that ties the distance to the actual distance measured for another constraint. For example, one constraint might say that the distance between vertex 20 and vertex 21 must be between 5 and 7. Another could then say that vertex 22 and vertex 23 must be the same distance apart as vertices 20 and 21.

When the sample pattern is defined in the first two sections, the vertices, points, and edges that comprise it have specific locations and are separated by exact distances. At this point all vertices are fixed. If a range constraint is given between two items that are part of the same polygon and where neither of them is a point, then all affected vertices (those either directly involved in the constraint or that are endpoints of an edge that is involved) become floating vertices, which disables any implicit constraints involving them. (With various implementations of the invention, a range constraint between a vertex and a point will not cause the vertex to become floating, but will only give a range to the point.) If a constraint is given between two items that are part of different polygons, then the vertices will not become floating, but all implicit constraints are disabled between the two polygons.

A fixed vertex radiates implicitly defined constraints to all other fixed vertices in the pattern except those that are part of other polygons where there are explicit constraints to that polygon. A floating vertex generates no implicit constraints. Edges that face each other have implicit constraints between them unless an explicit constraint is defined between them. If there are multiple polygons in the input pattern, there should be constraints (implicit or explicit) between them such that each polygon is linked to all of the others via constraints. It should be noted that a polygon may have no fixed vertices and therefore no implicit constraints, in which case explicit constraints should be provided.

With various examples of the invention, a point will be fixed based on the constraint between it and a vertex it is connected to with an edge. If the constraint between the two is a range, it will be placed at the farthest distance possible for each potential match of the pattern. Once its place is known, it may participate in other explicit constraints. A constraint between a vertex or point and an edge will be a projection constraint meaning that the vertex or point must be located perpendicular to the edge, and the distance will be measured along that perpendicular. Also, with some implementations of the invention, specifying a particular angle between two polygons may not be done directly, but may be achieved with two distance constraints between pairs of vertices.

Edges will be defined that connect one point to another, but each point should be connected to a vertex by a single edge. In other words, a point should not be sandwiched between two other points. Also, with some implementations of the invention, match found in the input may not have any additional vertices within the polygons in the pattern. Further, all polygons specified in the pattern should have at least two vertices and some dimension.

With various examples of the invention, if a range constraint is given between two edges of a polygon, the vertices will slide along the other edge they are connected to. For a rectangle, for example, if the rectangle is drawn 10 units wide, but it is constrained to be from 10 to 20 units wide, the vertices will be thought to slide out and the bottom edges will elongate to follow them. The layout of the polygons in the sample pattern indicate a basic layout of the pattern, which is used to infer where the polygons are relative to each other in the pattern. Also, with some implementations of the invention, a check may be performed to insure that a set of polygons that match the pattern do not intersect within the pattern area.

It is acceptable for a match to be made where separate polygons in the pattern are actually the same polygon in the input, as long as the connection occurs outside of the pattern. Also, implicit constraints may be generated from fixed vertices to points they are connected to by a single edge. Also, there may be implicit constraints between adjacent facing edges of different polygons. Typically, the basic layout will define the limits of how far polygons may move with respect to each other by indicating which edges must face each other in matched geometry. According to some implementations of the invention, only pairs of edges directly facing each other with no intervening pattern geometry may be considered.

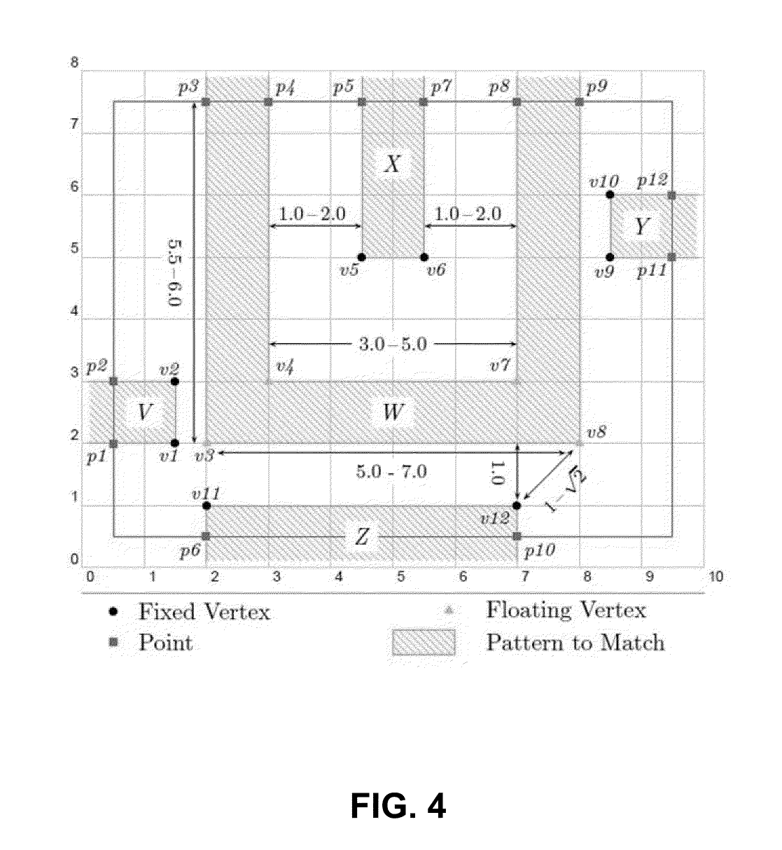

FIG. 4 shows a graphical example of a pattern template. The window of interest shown in red is illustrated to show this concept, but is not represented in the pattern description itself, nor does it affect the matched patterns. Also, the polygon area extending outside of the window of interest is illustrated only to make clear that an input polygon matching the pattern could extend beyond the pattern. The figure shows a number of the constraints, but not all of them. Also, the dimensions of the pattern are as shown graphically, except for the length of the horizontal portion of polygon W, which can be 1 unit longer or shorter than is pictured. Correspondingly, the distance between polygon X and the sides of W are ranges as well. Although not clearly marked as such in the figure, these two ranges are tied together and must be equal. This means that while the distance between the side of X and W can vary, X must be centered between the inside edges of W.

In this example, the vertices in V, X, Y, and Z are all fixed, meaning that in relation to other fixed vertices in the same polygon, they have an implicit constraint that is equal to the distance between them in the sample pattern. There are also implicit constraints between fixed vertices that comprise different adjacent polygons if there are no explicit constraints between the two polygons. Because the width of polygon W is flexible, the vertices defining its corners are floating, and therefore, no implicit constraints are generated for these vertices either within the polygon or to other polygons. Explicit constraints must be supplied from these vertices to the points above them.

FIG. 4 includes points (labeled pn) in the figure. The points that are part of V, X, Y, and Z do not need any explicit constraints to define their location. The points on polygon W do need to be explicitly constrained because the vertices they are connected to are floating. These constraints could be specified as simply an empty constraint between, say, vertex v4 and point p4, which would indicated that even though the vertex can float, the point is always going to be the same distance away from it as is indicated in the sample pattern.

It also should be noted that point p3 has a range constraint to vertex v3. This indicates that it will match an input polygon where that edge is at least as long as 5.5, and if it is longer, then p3 will be pushed out as far as 6.5 away from v3 without going past a vertex in the input geometry. Once it is set in place for that input, it can be used as a part of other constraints and when/if the input is clipped, the location of p3 will be the extent. Even though this is a range constraint, that in itself would not cause v3 to become floating.

Among polygons V, X, Y, and Z, implicit constraints are generated between all of the vertices because they are fixed, and there are no explicit constraints between the polygons. Constraints have been defined between W and X in such a way that X will always be centered in W. Considering at W and Z in isolation, they are explicitly constrained so that Z must be 1 unit away from W and it may slide so that v12 is from where v12 is in the figure to the point directly under v8. Since the constraint between v12 and the lower edge of W is a projection constraint, v12 can not slide farther over than v8, even though the constraint between v12 and v8 would allow that. When this relationship between W and Z is considered in the context of the other polygons, Z actually has to stay where it is relative to the other polygons because of the implicit constraints generated between them. To allow Z to slide, it would be necessary to generate range constraints from vertices or edges of Z to each of V, X, and Y.

There are currently no constraints, implicit or explicit, between V and W or between Y and W, but they are not needed because they are tied with implicit constraints to both X and Z. While W can expand sideways enough to touch Y, and there is currently no constraint to stop that happening, separate polygons in the pattern cannot touch or overlap in the input and be considered a match.

As previously discussed, with various examples of the invention the input data describing the illustrated pattern template will consist of three sections: a definition of the vertices and points with coordinates that make up the sample pattern, a listing of the edges with inside and outside indicated, and some number of constraints between vertices, points, and edges. The coordinates used for the vertices define a specific sample pattern, and from this are derived angles between edges within polygons and the basic layout of different polygons. The constraints must be such that the sample graph conforms to all constraints.

Each vertex or point is named with a ‘v’ or ‘p’ followed by a unique number. This is followed by its sample coordinate. A ‘v’ indicates a vertex that must correspond to an actual vertex in the pattern. A ‘p’ indicates a point, which may fall on an edge or vertex of the matched pattern. It is used to indicate that an edge must be at least a certain distance long, and is used to determine where to clip the input geometry before putting a match in the output.

(v|p)i:‘(‘n,m’)

Each edge is named with an ‘e’ followed by a unique number, followed by two vertex or point identifiers. The inside of the edge is the left side with the edge being drawn from the first to the second vertex.

ei:‘(’(v|p)n,(v|p)m)

Each constraint is named with ‘c’ followed by a unique number, followed by four different possibilities:
1. A null constraint indicating that the distance between these two items must be exactly the distance given in the sample pattern:

ci:(v|p|e)n(v|p|e)m
2. An exact distance constraint indicating that the distance between these two items must be exactly the distance given:

ci:(v|p|e)n(v|p|e)m ‘==’d
3. A range constraint indicating that the distance between these two items must be within the given range:

ci:(v|p|e)n(v|p|e)m ‘>=’d1‘<=’d2
4. An equivalent constraint tying the distance between these two items to the distance between the two items in an already defined constraint:

ci:(v|p|e)n(v|p|e)m cj

The corresponding textual definition for the graphical pattern shown in FIG. 3 is listed below:

v1: (1.5, 2.0)
v2: (1.5, 3.0)
v3: (2.0, 2.0)
v4: (3.0, 3.0)
v5: (4.5, 5.0)
v6: (5.5, 5.0)
v7: (7.0, 3.0)
v8: (8.0, 2.0)
v9: (8.5, 5.0)
v10: (8.5, 6.0)
v11: (2.0, 1.0)
v12: (7.0, 1.0)
p1: (0.5, 2.0)
p2: (0.5, 3.0)
p3: (2.0, 7.5)
p4: (3.0, 7.5)
p5: (4.5, 7.5)
p6: (2.0, 0.5)
p7: (5.5, 7.5)
p8: (7.0, 7.5)
p9: (8.0, 7.5)
p10: (7.0, 0.5)
p11: (9.5, 5.0)
p12: (9.5, 6.0)
e1: (p1, v1)
e2: (v1, v2)
e3: (v2, p2)
e5: (v3, v8)
e6: (v8, p9)
e7: (p8, v7)
e8: (v7, v4)
e9: (v4, p4)
e10: (p5, v5)
e11: (v5, v6)
e12: (v6, p7)
e13: (p12, v10)
e14: (v10, v9)
e15: (v9, p11)
e16: (p6, v11)
e17: (v11, v12)
e18: (v12, p10)
e19: (p2, p1)
e20: (p4, p3)
e21: (p7, p5)
e22: (p9, p8)
e23: (p12, p11)
e24: (p10, p6)
c1: v3 p3 >= 5.5 <= 6.0
c2: v4 p4
c3: v7 p8
c4: v8 p9
c5: e9 e10 >= 1.0 <= 2.0
c6: e12 e7 c5
c7: v4 v7 >= 3.0 <= 5.0
c8: v3 v8 >= 5.0 <= 7.0
c9: v12 e5 == 1.0
c10: v8 v12 >= 1.0 <= 1 <= 1.414

The geometry output by various embodiments of invention will be the matching patterns found in the input clipped at the edge of the pattern. This edge is found by pushing all of the points in the pattern out as far as their constraints and the input will allow, and then clipping the input from point to point. For example, in FIG. 3, a match of polygon W would be clipped from p3 to p4 and from p8 to p9.

### Properties

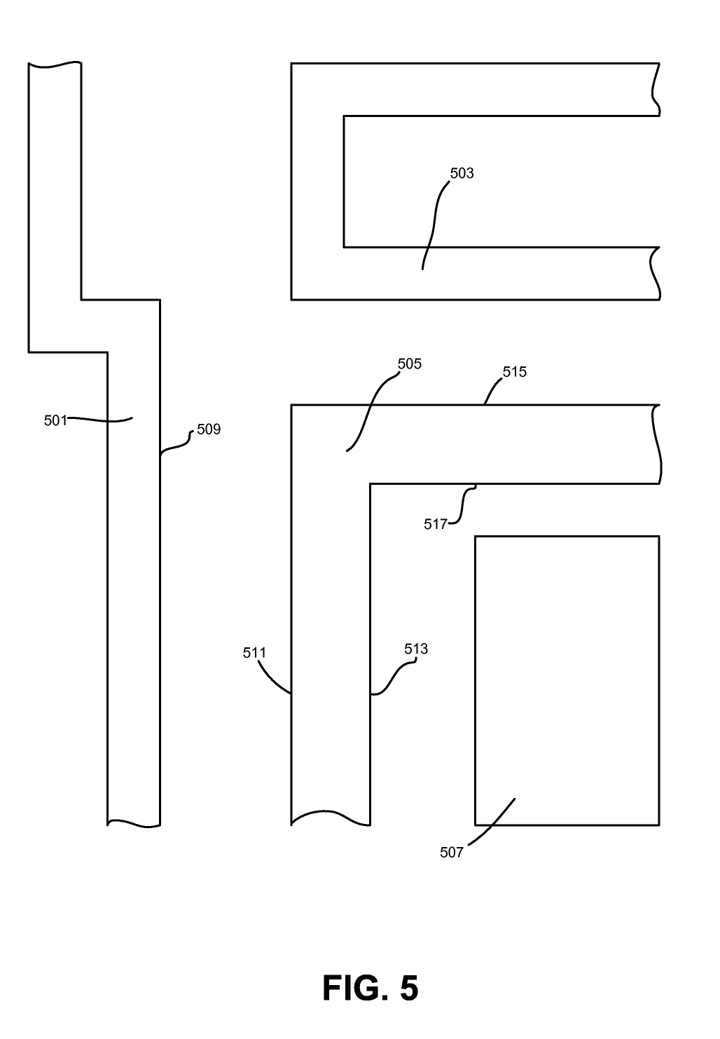

Various implementations of the invention relate to software tools for electronic design automation that create and/or employ associative properties. As will be discussed in more detail below, with some implementations of the invention, one or more properties can be generated and associated with any type of design object in a microdevice design. If the design is a physical layout for lithographically manufacturing an integrated circuit or other microdevice, for example, then one or more properties can be associated with any desired geometric element described in the design. Referring now to FIG. 5, this figure illustrates a portion of a layout design. The design includes a plurality of polygons 501-507 that will be used to form circuit structures in a layer of material, such as a layer of metal. Polygons 501-505, for example, may be used to form wiring lines for an integrated circuit. With various examples of the invention, one or more properties can be associated with a polygon, such as each of the polygons 501-507, or with a component of a polygon, such as the vertices of a polygon. Further, one or more properties can be associated with a polygon's edge, such as the edge 509 of the polygon 501. Still further, one or more properties can be associated with a pair of polygon edges, such as the edges 511 and 513 of the polygon 505. With various examples of the invention, each property may be represented as a new “layer” of data in the design.

When a property is associated with a design object in a layout design, its value may be derived from geometric data related to that design object. For example, if a property is associated with geometric element, such as a polygon, then it may have a value derived from the area of the polygon, the perimeter of the polygon, the number of vertices of the polygon, or the like. Similarly, if a property is associated with an edge, then the value of the property may be derived from the length or angle of the edge. Still further, if a property is associated with a pair of edges, then the value of the property may be derived from a separation distance between the edges, a total length of the edges, a difference in length between the edges, an area bounded by the edges, etc.

As will be apparent from the discussion below, however, it should be appreciated that a property value can be defined by any desired function. For example, a property may be defined as a constant value. The value of a property x thus may be defined by the function:

X=0.5

With this definition, the value of the property will always be 0.5.

A property's value also may be defined by a variable function. With a variable function, the value of a property may vary based upon, e.g., the specific data in the design. For example, a property x may be defined by the simple function:

X=AREA(METAL1)*0.5+(PERIMETER(METAL1)²

With this function, a property value is generated for every polygon in the design layer named “metal1.” (That is, the input used to generate the property x is the data layer in the design name “metal1.”) For each polygon in the design layer, the area of the polygon is calculated and multiplied by 0.5. In addition, the perimeter of the polygon is determined, and then squared. The multiplicand of the polygon's area with 0.5 is then added to the square of the polygon's perimeter to generate the value of the property x for associated with that polygon.

Thus, in FIG. 5, if the perimeter of the first polygon 501 is 68, and the area of the first polygon is 64, then the value of the property X₁ for the first polygon is

X₁=(64*0.5)+(68)²=4656

Similarly, if the perimeter of the second polygon 503 is 60 and the area of the second polygon is 66, then the value of the property X₂ of the second polygon is

X₂=(60*0.5)+(66)²=4386.

Still further, if the perimeter of the third polygon 505 is 60 and the area of the second polygon is 84, then the value of the property X₃ of the third polygon is

X₁=(60*0.5)+(84)²=7086,

and if the perimeter of the fourth polygon 507 is 34 and the area of the second polygon is 70, then the value of the property X₄ of the fourth polygon is

X₄=(34*0.5)+(70)²=4917

In addition to a “simple” function like that described above, a property also may be defined by a compound function that incorporates a previously-generated property value. For example, a first property x may be defined by the simple function described above:

X=AREA(METAL1)*5+(PERIMETER(METAL1)²

A second property, Y, can then be defined by a function that incorporates the value of the first property X, as follows:

Y=PROP(METAL1,X)+1

Thus, the value of the property Y for a polygon is the value of the property X calculated for that polygon, plus one.

In addition to being defined by simple and compound functions, a property may be defined so that no property value is generated under some conditions. For example, a property associated with a polygon may be defined so that, if the area of the polygon is smaller than a threshold value, then no value is generated for the property. This feature may be useful where, for example, property values need only be generated for design objects having desired characteristics. If a design object does not have the required characteristics, then no property will be generated for the design object and it can be ignored in subsequent calculations using the generated property values.

More generally, a property's value may be defined by alternative functions, such as the functions below:

IF AREA(METAL1)<0.5,THEN X=1

IF AREA(METAL1)>1,THEN X=AREA(METAL1)*0.5+(PERIMETER(METAL1))²

With these alternative functions, each polygon in the data layer “metal1” is analyzed. If the area of the polygon is below 0.5, then the value of the property X for the polygon is 1. Otherwise, the value of the property X for the polygon is the area of the polygon multiplied by 0.5, added to the square of the perimeter of the polygon.

A property may have multiple values. For example, a property may have an x-coordinate value, a y-coordinate value, and a z-coordinate value. Moreover, a property may have multiple, heterogeneous values. For example, a property may have a numerical value and a string value. Thus, a property associated with a cell can have a numerical value that may be, e.g., a device count of devices in the cell, while the string value may be, e.g., a model name identifying the library source for the cell. Of course, a property with multiple heterogeneous values can include any combination of value types, including any combination of the value types described above (e.g., one or more constant values, one or more vector values, one or more dynamic values, one or more alternate values, one or more simple values, one or more compound values, one or more alternate values, one or more string values, etc.).

Still further, the number of values of a property may change dynamically change. For example, a property K may have the values “a” and “b” (i.e., value of property K=a, b) before an electronic design automation process is executed. The electronic design automation process may then change the property to include a third value “c” (i.e., value of property K=a, b, c). Of course, the electronic design automation process also may alternately or additionally change the values of property K to one or more completely different values (e.g., value of property K=d, e, f). Moreover, with some implementations of the invention, the value of a property at one time may depend upon the value of the property at a previous time. For example, the value of a property Q at time t₂ may be derived from the value of the property Q at time t₁. Of course, in addition to constant values, and values generated based upon simple, compound, or alternative variable functions, a property's value can be specified according to any desired definition. For example, in addition to single or alternate mathematical functions, the value of a property may even be an array of constant values, variable functions, or some combination thereof. It should be appreciated, however, that, by using a scripting language as described above, property values can be dynamically generated during an electronic design automation process.

That is, by specifying property value definitions using a scripting language, the actual property values can be generated based upon the definitions when the design is analyzed during an electronic design automation process. If the data in the design is changed, then the property values will automatically be recalculated without requiring further input from the designer. Thus, employing a scripting language allows a designer or other user to develop properties and determine their values as needed. It also may provide the flexibility to allow third parties to develop new analysis techniques and methods, and then specify scripts that allow the user of an electronic design automation tool to use the scripts developed by a third party to generate property values for use with those new techniques and methods.

As previously noted, a property may be associated with any desired type of design object in a design. Thus, in addition to a single geometric element in a layout design, such as a polygon, edge, or edge pair, a property also can be associated with a group of one or more design objects in a layout design. For example, a property may be associated with a group of polygons or a hierarchical cell in a layout design (which themselves may be considered together as a single design object). A property also may be associated with an entire category of one or more design objects. For example, a property may be associated with every occurrence of a type of design object in a design layer, such as with every cell in a design, or every instance of a type of geometric element occurring in a design. A property also may be specifically associated with a particular placement of a cell in a design. In addition to design objects in a layout design, properties also may be associated with design objects in other types of designs, such as logical designs. A property thus may be associated with any desired object in a logical design, such as a net, a device, an instance of a connection pin, or even a placement of a cell in the design.

It also should be appreciated that, with various embodiments of the invention, a property associated with one design object also can be associated with another design object. Further, a property's value may be calculated using geometric or logical data for any desired design object, including design objects different from the design object with which the property is associated. With some implementations of the invention, a property's value may even be calculated using geometric or logical data for one or more design objects from multiple design data layers. For example, a designer may specify a design layer entitled “pair” that includes any specified edge pairs in a layout design, and another design layer entitled “edge” that includes specified edges in a layout design. A designer can then define a property z for each edge in the edge layer as:

Z=AREA(METAL1)/LENGTH(EDGE)+EW(PAIR)

where AREA is the area of one or more polygons related to the edge, LENGTH is the length of the edge, and EW is the width between the edges of an edge pair related to the edge. Thus, the value of the property Z for an edge is dependent upon the area of some other polygon related to the edge.

With some implementations of the invention, various algorithms can be used to define which design objects, such as geometric elements, will be related to each other for use in a property definition. For example, the definition for property z above may employ a relationship algorithm that includes a polygon in the property value determination if the polygon touches the edge associated with the property, and includes an edge pair in the property value determination if one edge is the edge associated with the property and the second edge is connected to the first edge through a polygon (i.e., both edges are part of the same polygon, as opposed to being separated by an empty space).

Of course, any desired algorithms can be used to determine which design objects will be related to each other for determining the value of a property. Other possible relationship algorithms for physical layout designs, for example, may relate all geometric elements that overlap, all geometric elements that intersect, all geometric elements that touch or otherwise contact each other, or all geometric elements that are within a defined proximity of another geometric element. With still other relationship algorithms, if one geometric element touches multiple geometric elements, the algorithms can decide to treat the touching geometric elements as errors, or to relate all touched shapes. Still other relationship algorithms can employ clipping, where, e.g., if a first geometric element intersects a second geometric element, only the part of the second geometric element inside the first geometric element is employed when determining a property value, etc.

Similarly, a variety of relationship algorithms can be used to relate design objects in a logical design to each other for use in a property definition. For example, a property definition may relate all design objects that belong to the same logical device, all design objects that share a common net, or all design objects that share a reference identifier with, e.g., the design object with which the property is associated. Of course, still other relationship criteria can be employed to relate design objects in designs to each other for use in a property definition.

Further, by defining a second property value so that it incorporates a first property value, a property value associated with any design object or group of design objects can be associated with any other design object or group of design objects. For example, a property for a first polygon may be the area of that polygon. A property for a second polygon touching or contacting that first polygon can then be defined as the area of the first polygon. In this manner, a property value associated with the first polygon can be associated with the second polygon. Thus, a property associated with a geometric element also can be associated with a cell incorporating that geometric element. Similarly, a property associated with a geometric element can be associated with an adjacent geometric element. Still further, a property of a geometric element can be associated with the entire data layer in a design.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth above. For example, while specific terminology has been employed above to refer to electronic design automation processes, it should be appreciated that various examples of the invention may be implemented using any desired combination of electronic design automation processes.

1. A method of identifying specific topological patterns in layout design data, comprising:
creating a search graph based upon topological features identified by applying a set of layout design analysis operations to identify topological features of the microdevice design data that include the set of topological features specified in the pattern template, and
analyzing the search graph to identify combinations of graph nodes and graph edges representing topological features that match the set of topological features specified in the pattern template.

2. The method recited in claim 1, wherein the pattern template includes a set of constraints that define how similar a topology in a layout design must be to the set of topological features in the pattern template to be considered a match with the pattern template.

3. The method recited in claim 1, wherein the search graph includes
graph nodes corresponding to geometric elements of the topological features identified by the layout design analysis operations, and
graph edges between the graph nodes representing characteristics of the topological features identified by the layout design analysis operations.

4. The method recited in claim 2, wherein the constraints include explicit constraints.

5. The method recited in claim 1, wherein applying the set of layout design analysis operations further analyzes the layout design data to determine properties associated with topological features of the layout design data to identify topological features of the layout design data that correspond with properties of the set of topological features specified in the pattern template.
